(19) United States
(12) Patent Application Publication
(10) Pub. No.: US 2011/0129030 A1
(43) Pub. Date: Jun. 2, 2011

(54) Method circuit and system for transmitting and/or receiving signals

(76) Inventor: Roy Oren, Magshimim (IL)

(21) Appl. No.: 12/926,306

(22) Filed: Nov. 9, 2010

(30) Foreign Application Priority Data
Nov. 27, 2009 (CN) 200910246590.5

(51) Int. Cl. H04L 27/04; H04L 27/06

(52) U.S. Cl. 375/295; 375/340

(57) ABSTRACT

Disclosed is a radio frequency digital transmitter adapted to transmit content using a frame based protocol where each (data) frame may be parsed into two or more timeslots. The transmitter may comprise a bandwidth adjustable modulator adapted to modulate a data frame provided by an encoder and an encoder adapted to encode each of a set of data services into one or more timeslots of the data frame, based on the bandwidth of the modulator. The encoder may select a number of timeslots to insert into the data frame based on the bandwidth of the modulator.

### FIELD OF THE INVENTION

The present invention relates generally to the field of communication. More specifically, the present invention relates to a method, circuit and system for transmitting and/or receiving signals.

### BACKGROUND

Modern communication networks are characterized by features such as high bandwidth/data-rate, complex communication protocols, various transmissions medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular and other wireless networks (e.g. 2G, 3G, CDMA, WCDMA, WiFi, mobile TV, digital TV, etc.) are used to supplement coverage for various devices (e.g. cell phone, wireless IP phone, wireless internet appliance, etc.) not physically connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for mobile communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA, FDMA and WiFi networks respectively. Signal attenuation and its resulting SNR degradation may limit bandwidth over a transmission medium, especially when the medium is air or open space.

Radio Frequency (“RF”) based wireless communication systems ranging from cellular communication systems to satellite radio broadcasting systems are highly prevalent, and their use is consistently growing. Due to the unshielded nature of the transmission medium of wireless RF based communication systems, they are particularly prone to various phenomena, including interference signals or noise and fading signals, which tend to limit performance of such systems.

Thus, strong and stable signals are needed for the proper operation of a wireless communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers (“LNAs”) and variable gain amplifiers (“VGAs”) in order to boost and adjust the strength and/or amplitude of a received signal.

An additional problem with wireless RF based transmissions is that they may be characterized by a multipath channel between the transmitter antenna and the receiver antenna which introduces “fading” in the received signal power. The combination of attenuation, noise interference and “fading” is a substantial limitation for wireless network operators, mitigating their ability to provide high data-rate services such as Internet access and video phone services.

Some modern RF receivers may use various techniques and circuits implementing these techniques to compensate for phenomenon resulting from weak signal and interference. For example, the gain settings of the internal amplifiers may be adjusted based on the condition of the RF spectrum in which the receiver operates. Methods for adjusting the gain of internal amplifiers based on signal interference are well known. However, they do not take into account the many variations and permutations of interference that may occur in a wireless communication network.

There exists a need in the field of wireless communications for methods, circuits, devices and systems for enhancing communication signal reception by a wireless receiver.

### SUMMARY OF THE INVENTION

The present invention is a circuit, system and method for receiving and/or transmitting a signal. According to some embodiments of the present invention, a transmitter may be adapted to transmit content, signals or transmissions using a frame based protocol, where each frame is parsed or divided into two or more timeslots. The transmitter may consist of a bandwidth (BW) adjustable modulator and an encoder and an input. The modulator may be able to modulate a data frame provided by an encoder. The encoder may be able to encode a set of data services into one or more timeslots of the frame (also referred to as dataframe or data frame) according to the selected BW. The duration of the timeslot may vary according to the BW. The input may indicate the requested BW. The modulator BW may have a nominal or default value and selected BW may be higher, lower or equal to default BW.

According to some embodiments of the present invention, the number of timeslots may depend on the BW while the frame duration is constant.

According to some embodiments of the present invention, the number of frames is constant while the duration of each timeslot (and in accordance the frame's duration) depends on the BW.

According to some embodiments of the present invention, an input, signal, which may indicate the requested BW, may control or otherwise influence a clock associated with the transmitter so that changing the clock at a first ratio may lead to changing the modulator BW by a second ratio. Optionally, the first and second ratios may be identical.

According to some embodiments of the present invention, a receiver may be adapted to receive content, signals or transmissions using a frame based protocol, where each frame is parsed or divided into two or more timeslots. The receiver may consist of a bandwidth adjustable demodulator, a decoder and an input. The demodulator may be able to demodulate a data frame. The decoder may be able to decode one or more timeslots of the dataframe according to the selected BW and extract a set of data services. The expected duration of the timeslot may vary according to the BW. The input may indicate the requested BW. The demodulator BW may have a nominal or default value and selected BW may be higher, lower or equal to default BW.

According to some embodiments of the present invention, the number of timeslots may depend on the BW while the frame duration is constant.

According to some embodiments of the present invention, the number of frames is constant while the duration of each timeslot (and in accordance the frame's duration) depends on the BW.

According to some embodiments of the present invention, the input, which may indicate the requested BW, may control a clock associated with the receiver so that changing the clock at a first ratio may lead to changing the demodulator BW by a second ratio. Optionally, the first and second ratios are approximately the same.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are a functional block diagram of a digital transmitter; and

FIGS. 2A and 2B are a functional block diagram of a digital receiver; and

FIG. 3A shows a digital transmitter transmission flow chart; and

FIG. 3B shows a digital receiver reception flow chart; and

FIGS. 4A, 4B & 4C show typical data sequences.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus. The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to some embodiments of the present invention, a radio frequency digital transmitter may be adapted to transmit content using a frame based protocol, where each frame may be parsed into two or more timeslots. The transmitter may comprise: a bandwidth adjustable modulator adapted to modulate a data frame provided by an encoder; and an encoder adapted to encode each of a set of data services into one or more timeslots of the dataframe, based on the bandwidth of the modulator. The encoder may select a number of timeslots to insert into the dataframe based on the bandwidth of the modulator. The transmitter may further comprise an input adapted to control bandwidth of the modulator. The transmitter may further comprise an adjustable clock adapted to control modulator bandwidth. The transmitter may further be adapted to comply with the CMMB standard.

According to some embodiments of the present invention, a radio frequency digital transmitter may be adapted to transmit content using a frame based protocol, where each frame is parsed into two or more timeslots. The transmitter may comprise a bandwidth adjustable modulator adapted to modulate a data frame provided by an encoder; and an encoder adapted to encode each of a set of data services into one or more timeslots of the dataframe, based on the bandwidth of said modulator wherein the encoder may select a duration of a dataframe based on the bandwidth of the modulator. The transmitter may further comprise an input adapted to control bandwidth of the modulator. The transmitter may further comprise an adjustable clock adapted to control duration of a dataframe. The transmitter may be further adapted to comply with the CMMB standard.

According to some embodiments of the present invention, a radio frequency digital receiver may be adapted to receive content complying with a frame based protocol, where each frame is parsed into two or more timeslots. The receiver may comprise a bandwidth adjustable demodulator adapted to demodulate a data frame; and a decoder adapted to decode one or more timeslots of the dataframe and may extract a set of data services, based on the bandwidth of said demodulator. The decoder may decode according to a number of timeslots within a dataframe based on the bandwidth of the demodulator. The receiver may further comprise an input adapted to control bandwidth of the demodulator. The receiver may further comprise an adjustable clock adapted to control demodulator bandwidth. The receiver may be further adapted to comply with the CMMB standard.

According to some embodiments of the present invention, a radio frequency digital receiver may be adapted to receive content complying with a frame based protocol, where each frame is parsed into two or more timeslots. The receiver may comprise a bandwidth adjustable demodulator adapted to demodulate a data frame; and a decoder adapted to decode one or more timeslots of the dataframe and may extract a set of data services, based on the bandwidth of the demodulator. The decoder may decode according to a duration of a timeslot based on the bandwidth of the demodulator. The receiver may further comprise an input adapted to control bandwidth of the demodulator. The receiver may further comprise an adjustable clock adapted to control expected frame duration. The receiver may be further adapted to comply with the CMMB standard.

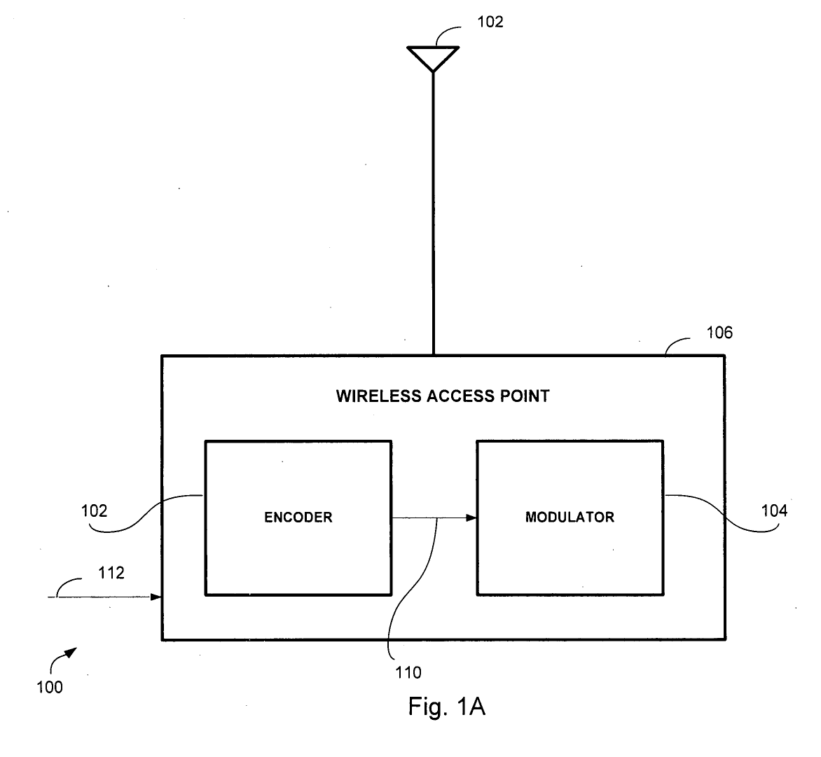

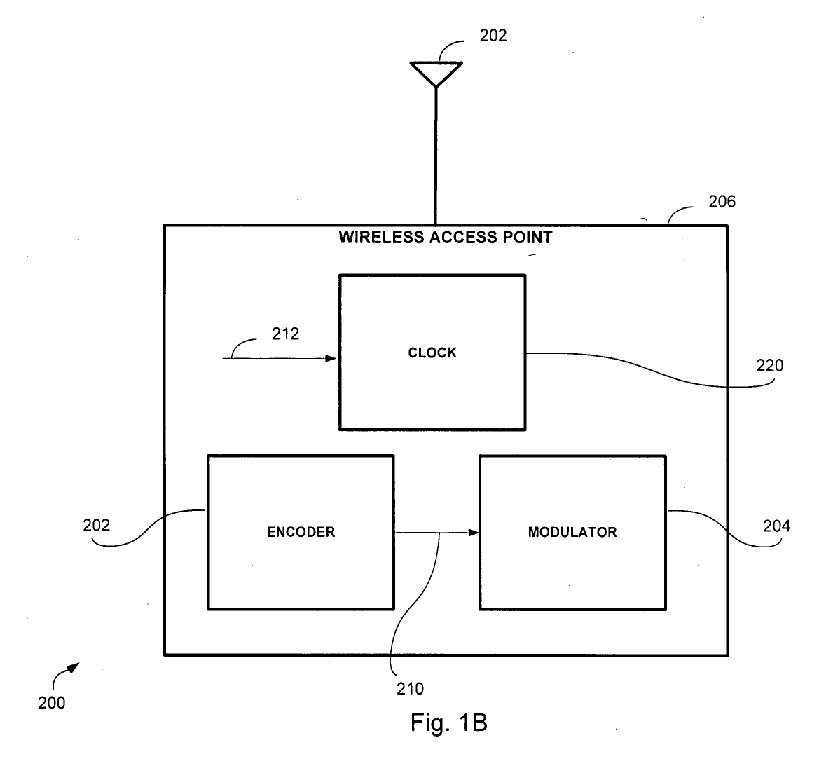

Turning now to FIG. 1A, depicted is a digital transmitter, such as digital transmitter 100 which may transmit content using a frame based protocol such as time division multiple access (TDMA), carrier sense multiple access (CSMA), code division multiple access (CDMA), evolution data optimized (EVDO), wideband code division multiple access (WCDMA), Frequency division multiple access (FDMA) and/or wireless local area network (such as WiFi) but not limited to these examples. Digital transmitter 100 may transmit content in a frame based protocol where each frame is parsed into two or more timeslots. Digital transmitter 100 is further comprised of a bandwidth adjustable modulator, such as modulator 102 and an encoder, such as encoder 104. Modulator 102 and encoder 104 may be embedded on a same circuit or be situated near each other and may be part of a wireless access point such as wireless access point 106. Wireless access point 106 may further comprise a RF antenna(s) such as antenna 108 which may transmit the content in a frame based protocol signal(s).

Encoder 102 may encode a set of data services into one or more timeslots of the dataframe based on the bandwidth of modulator 102. Modulator 102 is a bandwidth adjustable modulator and may modulate a data frame such as data frame 110 provided by encoder 102.

According to some embodiments of the present invention, digital transmitter 100 may be operable at different bandwidths. Antenna 108 may transmit a frame that has a set duration and may parse the frame to two or more frames according to the bandwidth (BW) associated with the modulator. For example, when modulator 102 is operable at a 8 MHz BW then a frame duration of 1 second will have 40 frames as compliant with the China Multimedia Mobile Broadcasting (CMMB) standard. In another example, when modulator 102 is operable at a 5 Mhz BW then a frame duration of 1 second may have 25 time slots.

According to some embodiments of the present invention, antenna 108 may transmit a frame that has a set number of frames and the duration of the timeslots and frame are dependant on the BW. For example, when modulator 102 is operable at a 8 MHz BW then a frame duration of 1 second will have 40 frames as compliant with the China Multimedia Mobile Broadcasting (CMMB) standard and when modulator 102 is operable at a 5 Mhz BW then a frame duration may be 1.6 seconds and may have 40 time slots.

According to some embodiments of the present invention, wireless access point 106 may have an input such as input 112 that may modify the number of time slots or the duration of the timeslots according to the modulator BW. Input 112 may be a digital signal, a clock signal or other functionally designed to control number of time slots according to modulator BW.

Turning now to FIG. 1B, depicted is a digital transmitter such as digital transmitter 200. It is understood that digital transmitter 200 may essentially be the same as digital transmitter 100. Accordingly blocks 202-210 may essentially be the same as corresponding 102-110. Digital transmitter 200 further comprises a clock such as clock 220 which may be associated with modulator 204, encoder 202 and/or additional circuits that wireless access point 206 may be comprised of. Clock 220 may be integral, internal or external to wireless access point 206. An input such as input 212 may control frequency of clock 220 so that modulator frequency is scaled down or up accordingly. For example, when modulator 202 is operable at a 8 MHz BW then a frame duration of 1 second may have 40 time slots as compliant with the CMMB standard and clock 220 may function at a first frequency. In another example, when modulator 202 is operable at a 5 Mhz BW then a frame duration of 1 second may have 25 time slots; so that modulator can adjust number of time slots according to baseband frequency. In another example, when modulator 202 is operable at a 5 Mhz BW a frame duration of 1.6 seconds may have 40 time slots and clock 220 may have a second frequency, for example, approximately ⅝ of the first frequency.

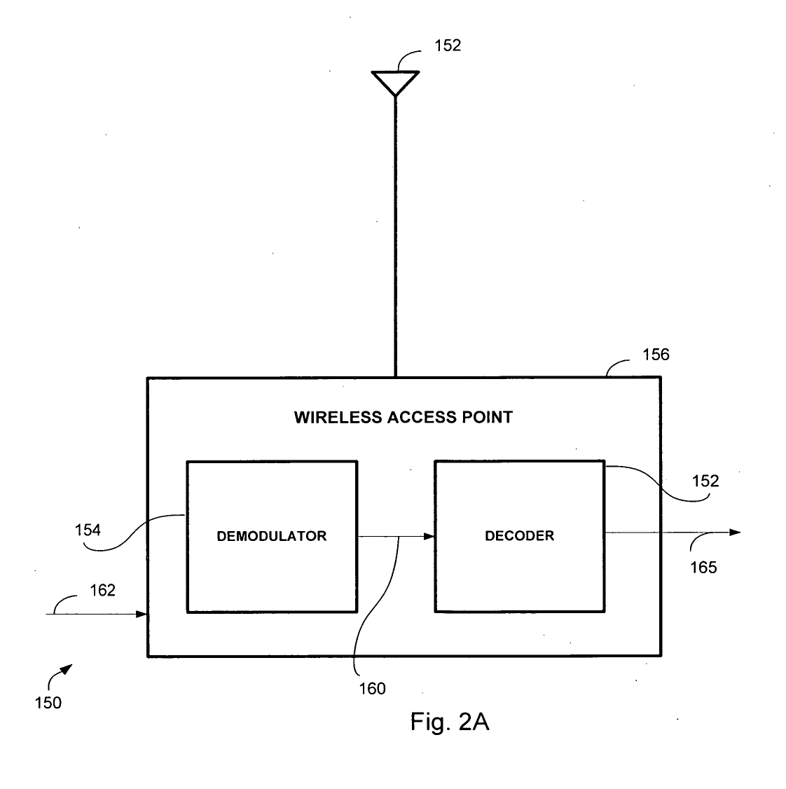

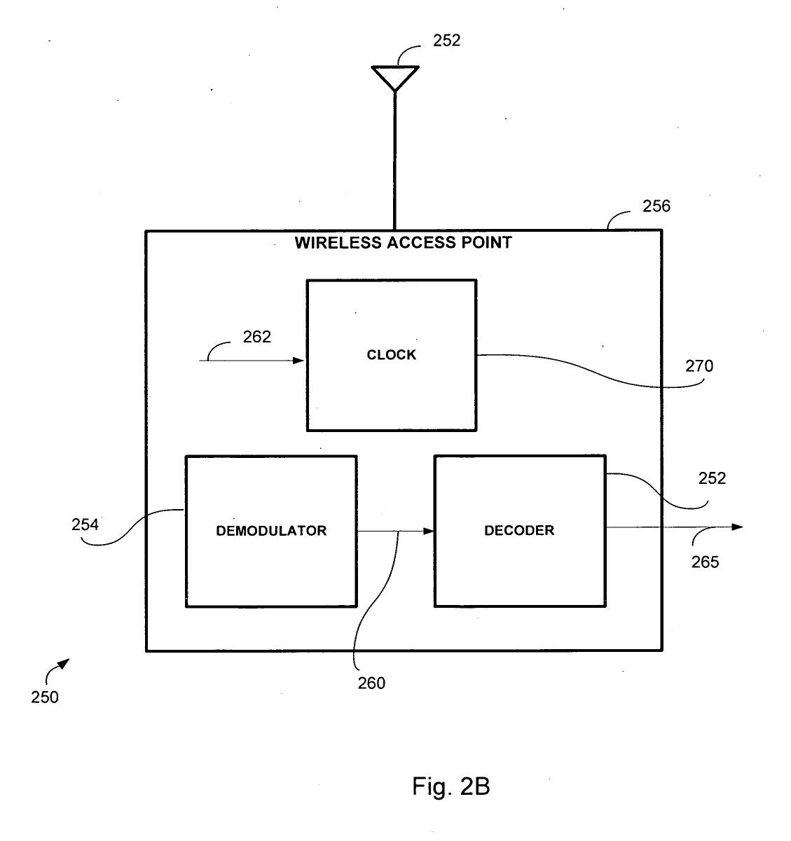

Turning now to FIG. 2A, depicted is a digital receiver, such as digital receiver 150. Receiver 150 may receive content complying with a frame based protocol such as time division multiple access (TDMA), carrier sense multiple access (CSMA), code division multiple access (CDMA), evolution data optimized (EVDO), wideband code division multiple access (WCDMA), Frequency division multiple access (FDMA) and/or wireless local area network (such as WiFi) but not limited to these examples. Digital receiver 150 may receive content in a frame based protocol where each frame is parsed into two or more timeslots. Digital receiver 150 is further comprised of a bandwidth adjustable demodulator such as demodulator 152 and a decoder such as decoder 154. Demodulator 152 and decoder 154 may be embedded on a same circuit or be situated near each other and may be part of a wireless access point such as wireless access point 156. Wireless access point 156 may further comprise a RF antenna(s) such as antenna 158 which may receive the content in a frame based protocol signal(s).

Demodulator 152 may be a bandwidth adjustable demodulator and may demodulate a signal complying with a frame based protocol, based on the bandwidth of the demodulator. Decoder 152 may then decode the demodulated signal and output a data signal such as output 165. Output 165 may be a video stream, multimedia data or other.

According to some embodiments of the present invention, digital receiver 150 may be operable at different bandwidths. Antenna 158 may receive a frame that has a set duration and may demodulate the frame according to the bandwidth (BW). For example, when demodulator 152 is operable at an 8 MHz BW then a frame duration of 1 second will have 40 time slots as compliant with the China Multimedia Mobile Broadcasting (CMMB) standard and when demodulator 152 is operable at a 5 Mhz BW then a frame duration of 1 second may have 25 time slots.

According to some embodiments of the present invention, Antenna 158 may expect to receive a frame that may have a set number of frames and a different duration for each timeslot depending on the demodulator BW. For example, when demodulator 152 is operable at a 8 MHz BW then a frame duration of 1 second will have 40 time slots will be expected as compliant with the China Multimedia Mobile Broadcasting (CMMB) standard and when demodulator 152 is operable at a 5 Mhz BW then a frame duration may be 1.6 seconds and may have 40 time slots may be expected.

According to some embodiments of the present invention, wireless access point 156 may have an input such as input 162 that may enable or activate demodulator 152 to demodulate a signal to the demodulator 152 BW. Input 162 may be a digital signal, a clock signal or other functionally designed to control number of expected time slots in a frame according to demodulator 152 BW.

According to some embodiments of the present invention, input 162 may indicate the expected duration of a frame. Input 162 may be a digital signal, a clock signal or other functionally designed to control demodulator 152 BW.

Turning now to FIG. 2B, depicted is a digital receiver such as digital receiver 250. It is understood that digital receiver 250 may essentially be the same as digital receiver 150. Accordingly items 252-265 may essentially be the same as corresponding 152-165. Digital transmitter 250 further comprises a clock such as clock 270 which may be associated with demodulator 254, decoder 252 and/or additional circuits that wireless access point 256 may be comprised of. Clock 270 may be integral, internal or external to wireless access point 256. An input such as input 262 may control frequency of clock 270 so that demodulator frequency is scaled down or up accordingly. For example, when demodulator 252 is operable at a 8 MHz BW then a frame duration of 1 second may have 40 time slots as compliant with the CMMB standard and clock 270 may function at a first frequency. In another example, when demodulator 252 is operable at a 5 Mhz BW then a frame duration of 1 second may have 25 time slots; so that demodulator 252 can adjust number of time slots according to baseband frequency. In another example, when demodulator 252 is operable at a 5 Mhz BW a frame duration of 1.6 seconds may have 40 time slots and clock 270 may have a second frequency, for example, approximately ⅝ of the first frequency.

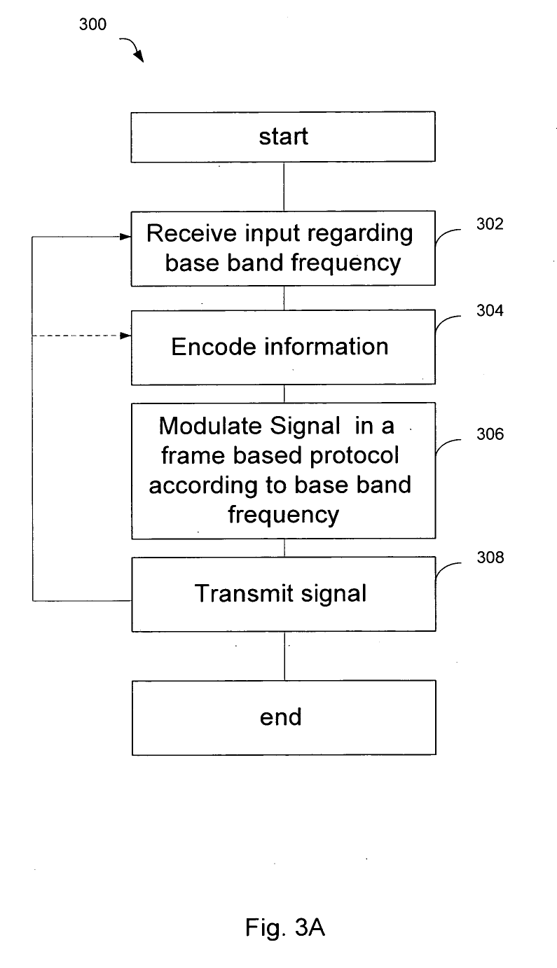

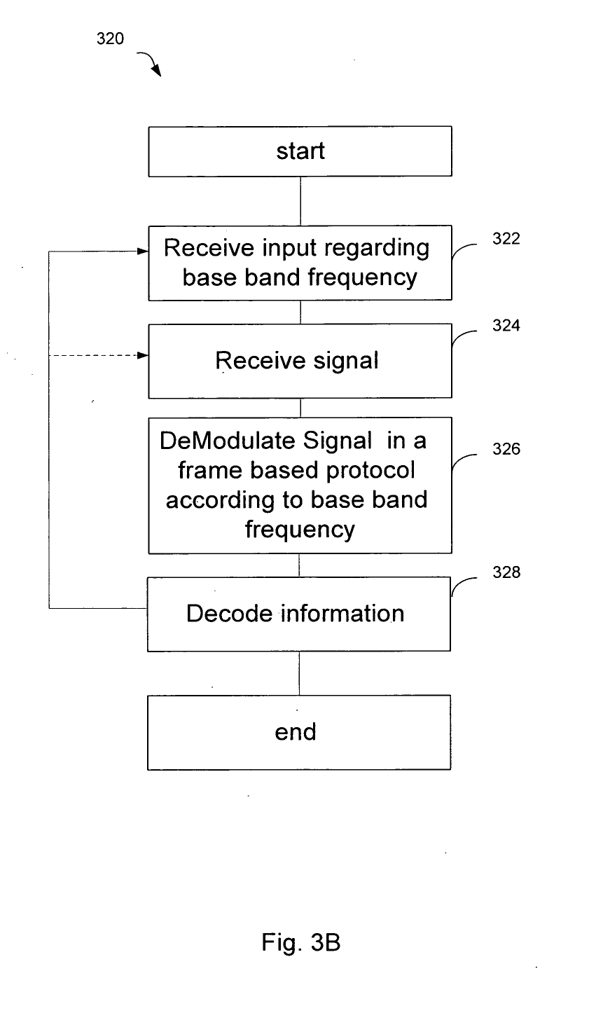

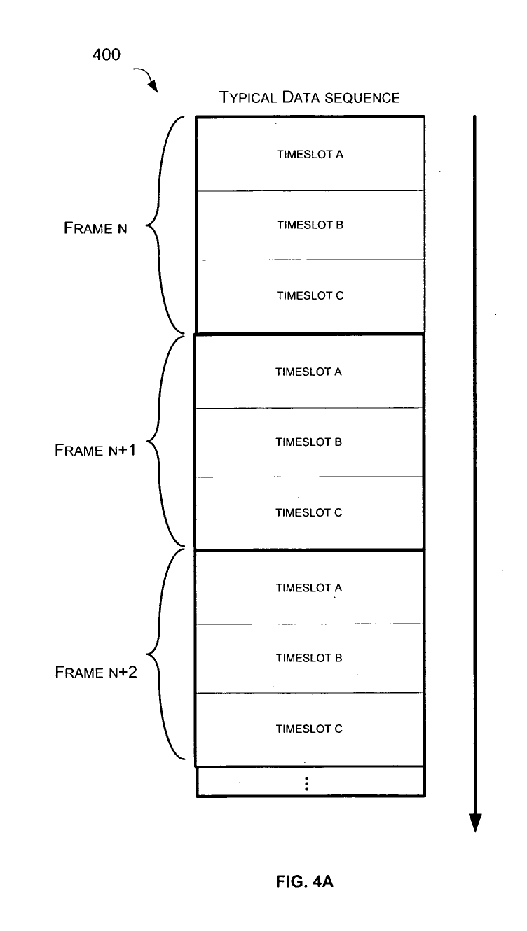

Turning now to FIG. 3A, there is shown a digital transmitter transmission flow chart, as seen in flow chart 300. The digital transmitter may receive an input selecting the baseband bandwidth as described in step 302. The input may be the clock frequency, a digital input, a file or other. The digital transmitter may encode information that needs to be transmitted as described in step 304. Following this step the digital transmitter may modulate the content using a frame based protocol, where each frame is parsed into two or more timeslots as described in step 306. The duration of the frame may be predetermined while the number of timeslots that the frame is parsed or divided into may be associated with the input described in step 302. The digital transmitter may then transmit the signal via a RF antenna as described in step 308.

Turning now to FIG. 3B, there is shown a digital receiver reception flow chart, as seen in flow chart 320. The digital receiver may receive an input selecting the baseband bandwidth as described in step 322. The input may be the clock frequency, a digital input, a file or other. The digital receiver may then receive transmitted data or data as described in step 324. The digital receiver may then demodulate the signal in a frame based protocol according to a base band frequency as described in step 326. Accordingly, the duration of a frame or the number of frames in a frame may be dependant on the BW. The receiver may then decode the information as described in step 328. Optionally, the receiver may than receive information regarding a new BW (step 322) or may receive a new signal (step 324) and skip step 322.

According to some embodiments of the present invention, receiving the input regarding the base band of the information to demodulate as described in step 322 may be continues, may occur once at the initialization of digital transmitter, may occur once every several times the digital transmitter completes a transmission, may occur when a new input base band selecting input is detected and more but not limited to these examples.

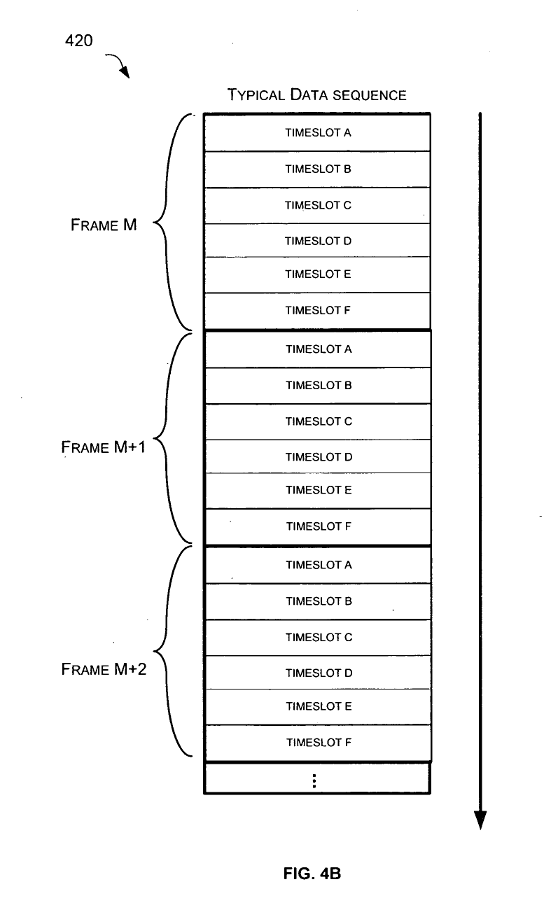

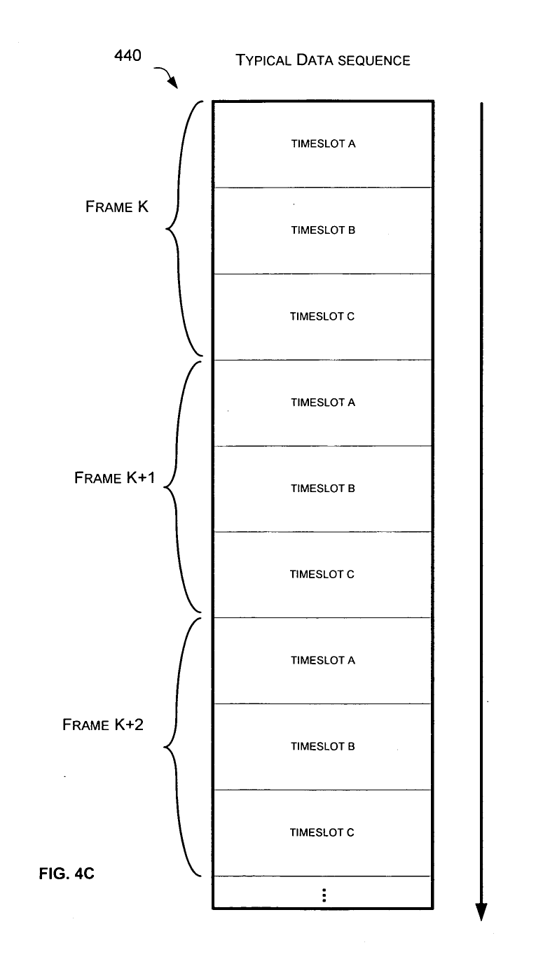

Turning now to FIG. 4A, there is shown a typical data sequence, as seen in data sequence 400. The data sequence may be associated with a transmission of a digital transmitter such as digital transmitter 100 of FIG. 1A or digital transmitter 200 of FIG. 1B. In a typical frame such as frame N there are 3 timeslots A-C with essentially the same duration, approximately ⅓ of the duration of frame N. Frame N+1 is divided essentially the same as Frame N. It is understood that the data encoded into TIMESLOT A of Frame N may be different than the data encoded into TIMESLOT A of Frame N+1.

Turning now to FIG. 4B, there is shown a typical data sequence, as seen in sequence 420. The data sequence may be associated with a transmission of a digital transmitter such as digital transmitter 100 of FIG. 1A or digital transmitter 200 of FIG. 1B. It is understood that the two sequences are similar and that Frame N of FIG. 4A and Frame M of FIG. 4B may have the same duration. However, Frame M may be divided into a different number of frames than Frame N. Timeslots A-F of FIG. 4B may each be of a duration of ⅙ of the duration of Frame M.

Turning now to FIG. 4C, there is shown a typical data sequence, as seen in sequence 420. The data sequence may be associated with a transmission of a digital transmitter such as digital transmitter 100 of FIG. 1A or digital transmitter 200 of FIG. 1B. It is understood that the two sequences are similar and that Frame M of FIG. 4A and Frame K of FIG. 4C may have a different duration. However, Frame M may be divided into the same number of frames as Frame N. Timeslots A-C of FIG. 4C may all be of a different duration than corresponding timeslots of Frame M. The different durations of timeslots and frames between FIGS. 4A and 4C may be associated with the different BW.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A radio frequency digital transmitter adapted to transmit content using a frame based protocol, where each frame is parsed into two or more timeslots, said transmitter comprising:
a bandwidth adjustable modulator adapted to modulate a data frame provided by all encoder; and
an encoder adapted to encode each of a set of data services into one or more timeslots of the frame based on the bandwidth of said modulator, and wherein said encoder is adapted to select a number of timeslots to insert into the frame based on the bandwidth of said modulator.

2. The transmitter according to claim 2, further comprising an input adapted to control bandwidth of said modulator.

3. The transmitter according to claim 2, further comprising an adjustable clock adapted to control modulator bandwidth.

4. The transmitter according to claim 2, further adapted to comply with the Chinese Multimedia Mobile Broadcasting (“CMMB”) standard.

5. A radio frequency digital transmitter adapted to transmit content using a frame based protocol, where each frame is parsed into two or more timeslots, said transmitter comprising:
a bandwidth adjustable modulator adapted to modulate a data frame provided by an encoder; and
an encoder adapted to encode each of a set of data services into one or more timeslots of the frame based on the bandwidth of said modulator, and wherein said encoder is adapted to select a duration of a frame based on the bandwidth of said modulator.

6. The transmitter according to claim 5, further comprising an input adapted to control bandwidth of said modulator.

7. The transmitter according to claim 5, further comprising an adjustable clock adapted to control duration of a frame.

8. The transmitter according to claim 5, further adapted to comply with the Chinese Multimedia Mobile Broadcasting (“CMMB”) standard.

9. A radio frequency digital receiver adapted to receive content complying with a frame based protocol, where each frame is parsed into two or more timeslots, said receiver comprising:
a bandwidth adjustable demodulator adapted to demodulate a data frame;
a decoder adapted to decode one or more timeslots of the frame and to extract a set of data services based on the bandwidth of said demodulator; and
wherein said decoder decodes according to a number of timeslots within a frame based on the bandwidth of said demodulator.

10. The receiver according to claim 9, further comprising an input adapted to control bandwidth of said demodulator.

11. The receiver according to claim 9, further comprising an adjustable clock adapted to control demodulator bandwidth.

12. The receiver according to claim 9, further adapted to comply with the Chinese Multimedia Mobile Broadcasting (“CMMB”) standard.

13. A radio frequency digital receiver adapted to receive content complying with a frame based protocol, where each frame is parsed into two or more timeslots, said receiver comprising:
a bandwidth adjustable demodulator adapted to demodulate a frame;
a decoder adapted to decode one or more timeslots of the frame and to extract a set of data services based on the bandwidth of said demodulator; and
wherein said decoder is further adapted to decode according to a duration of a timeslot based on the bandwidth of said demodulator.

14. The receiver according to claim 13, further comprising an input adapted to control bandwidth of said demodulator.

15. The receiver according to claim 13, further comprising an adjustable clock adapted to control expected frame duration.

16. The receiver according to claim 13, further adapted to comply with the Chinese Multimedia Mobile Broadcasting (“CMMB”) standard.
